(19) United States
(12) Patent Application Publication
(10) Pub. No.: US 2024/0339688 A1
(43) Pub. Date: Oct. 10, 2024

(54) METHOD FOR RECOVERING ACTIVE MATERIAL FROM WASTE BATTERY BY DESORPTION

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/681,884

(22) PCT Filed: Dec. 9, 2022
(86) PCT No.: PCT/CN2022/137817

§ 371 Date: Feb. 7, 2024

(30) Foreign Application Priority Data
Feb. 17, 2022 (CN) 202210145331.9

(51) Int. Cl. H01M 10/54; B09B 3/40; B09B 3/70; B09B 101/16

(52) U.S. Cl. CPC H01M 10/54; B09B 3/40; B09B 3/70; B09B 2101/16

(57) ABSTRACT

The present disclosure discloses a method for recovering active material from waste battery by desorption, comprising steps of: reacting wound cores of cathode and anode current collectors of waste battery with carbon tetrachloride and chlorine to obtain remaining wound cores, a solution of aluminum chloride in carbon tetrachloride and a first desorption powder of cathode; soaking the remaining wound cores and the first desorption powder of cathode in water to obtain soaked wound cores, a lithium salt solution and a second desorption powder of cathode; and reacting the soaked wound cores with nitric acid to obtain a copper nitrate solution and a desorption powder of anode. The waste lithium-ion battery only needs to be discharged and disassembled, and no shredding process is required, which avoids steps of shredding and sorting, reduces equipment investment. In addition, cathode and anode materials can be effectively recovered, and the product has high economic value.

### FIELD

The present disclosure belongs to the field of battery recycling, and specifically relates to a method for recovering active material from waste battery by desorption.

### BACKGROUND

Lithium-ion batteries have a complex structure and are composed of shells, separators, cathodes, anodes, etc. The anode is composed of graphite, binder, conductive agent and current collector copper foil, and the cathode is obtained by coating active material powder, binder and conductive agent on current collector aluminum foil. The cathode active material powder mainly includes LiCoO₂, LiNiO₂, LiMnO₂, LiFePO₄ and LiNiₓCo_{y}Mn_{1-x-y}O₂, etc. In the process of recycling waste batteries, it is necessary to separate their different components through a series of methods.

Waste lithium-ion batteries usually have a certain residual voltage. If not properly handled, they will easily cause auto-ignition and explosion, which will threaten the safety of operators. Based on this, the pretreatment process of waste lithium-ion batteries usually includes pre-discharge, shredding and disassembling of batteries, and desorption of current collectors.

In the process of mechanical shredding and sorting, in order to improve the recovery rate of active material powder, 2-3 times of shredding is required to reduce the particle size of the debris. However, this will inevitably increase the difficulty of sorting and reduce the recovery grade of the separated components. A single mechanical shredding and sorting is difficult to take both the recovery rate and recovery grade of the active material into account. Therefore, it is particularly important to desorb the active material powder from current collectors by other technical means.

At present, the separation of active materials and current collectors mainly focuses on three aspects: (1) According to the characteristics of metal aluminum capable of dissolving in alkaline solution, soaking the wound core of cathode in alkaline solution can achieve the purpose of separating the cathode powder and current collector. This method has the advantages of low energy consumption and strong operability, but the current collector aluminum foil enters the solution in the form of ions, which requires further recycling. In addition, this process requires a large amount of alkaline solution. In order to prevent secondary contamination by the alkaline solution, neutralization treatment is necessary, which will require additional cost overhead. In order to avoid the contamination of the powder by the introduced alkaline solution, the desorbed active substances should be fully rinsed or neutralized with acid during the filtration process; (2) Organic solvents are used to dissolve the binder PVDF (polyvinylidene fluoride), so that the current collector metal wound core can be recovered in the form of solid. However, the organic solvents are usually expensive and are not suitable for large-scale industrial applications. In addition, dissolution with organic solvents is not suitable for separating all types of binders, for example, when the binder used in lithium-ion batteries is PTEE (polytetrafluoroethylene), the dissolution of organic solvents such as NMP (N-methylpyrrolidone) is negligible; and (3) Direct heating to a specific temperature in the air can deactivate the binder to achieve the purpose of separating the current collector aluminum foil. However, the pyrolysis process usually requires a high temperature, and the binder and organic electrolyte will decompose to produce toxic and harmful gases such as HF during high-temperature pyrolysis, requiring additional exhaust gas purification and treatment devices.

### SUMMARY

In order to overcome the problem that the active material in waste batteries cannot be effectively recovered in the prior art, the purpose of the present disclosure is to provide a method for recovering active material from waste battery by desorption.

In order to achieve the above object, the technical solution adopted by the present disclosure is:

A method for recovering active material from waste battery by desorption, comprising steps of:
(1) mixing a wound core of cathode current collector and a wound core of anode current collector of waste lithium-ion battery with carbon tetrachloride in a reaction device;
(2) introducing chlorine into the reaction device in step (1) for reaction;
(3) removing the remaining wound cores after the reaction in step (2), and performing solid-liquid separation on the remaining material in the reaction device to obtain a solution of aluminum chloride in carbon tetrachloride and a first desorption powder of cathode;
(4) soaking the wound cores and the first desorption powder of cathode in step (3) in water, removing the soaked wound cores, and performing solid-liquid separation on the remaining material to obtain a lithium salt solution and a second desorption powder of cathode; and
(5) reacting the soaked wound cores in step (4) with a nitric acid solution and performing solid-liquid separation to obtain a copper nitrate solution and a desorption powder of anode,
wherein in step (1), the wound core of cathode current collector and the wound core of anode current collector of waste lithium-ion battery are obtained by discharging and disassembling the waste lithium-ion battery; and
in step (1), the wound core of cathode current collector includes aluminum foil and the wound core of anode current collector includes copper foil.

Preferably, in the method for recovering active material from waste battery by desorption, in step (1), the waste lithium-ion battery includes at least one selected from the group consisting of ternary lithium-ion battery, lithium iron phosphate battery, lithium cobalt oxide battery, lithium manganate battery and lithium nickelate battery; further preferably, the waste lithium-ion battery is at least one selected from the group consisting of lithium iron phosphate battery, ternary lithium battery and lithium cobalt oxide battery; even more preferably, the waste lithium-ion battery is lithium iron phosphate battery.

Preferably, in the method for recovering active material from waste battery by desorption, in step (1), the amount of carbon tetrachloride needs to be enough so that the carbon tetrachloride solution can cover the wound core.

Preferably, in the method for recovering active material from waste battery by desorption, in step (2), a temperature of the reaction is 70-120° C.; further preferably, a temperature of the reaction is 80-120° C. A temperature of the reaction may be 80° C., 90° C., 100° C., 110° C. or 120° C.

Preferably, in the method for recovering active material from waste battery by desorption, the top of the reaction device is provided with a condenser; further preferably, a condensation temperature of the condenser is ≤60° C.; further preferably, a condensation temperature of the condenser is ≤55° C.; even more preferably, a condensation temperature of the condenser is ≤50° C.

Preferably, in the method for recovering active material from waste battery by desorption, in step (2), the chlorine is dry chlorine.

Preferably, in the method for recovering active material from waste battery by desorption, in step (2), the reaction ends when the solids are no longer reduced.

Preferably, in the method for recovering active material from waste battery by desorption, step (3) further comprises a separation step of aluminum chloride and carbon tetrachloride: evaporating the solution of aluminum chloride in carbon tetrachloride to obtain anhydrous aluminum chloride and carbon tetrachloride; further preferably, under the condition of 70-75° C., evaporating the solution of aluminum chloride in carbon tetrachloride to obtain anhydrous aluminum chloride and carbon tetrachloride.

Preferably, in the method for recovering active material from waste battery by desorption, in step (4), a duration of soaking in water is 6-40 min; further preferably, a duration of soaking in water is 8-35 min; even more preferably, a duration of soaking in water is 10-30 min.

Preferably, in the method for recovering active material from waste battery by desorption, in step (4), the water is deionized water.

Preferably, in the method for recovering active material from waste battery by desorption, in step (5), a concentration of the nitric acid solution is 0.5-9 mol/L; further preferably, a concentration of the nitric acid solution is 0.8-8.5 mol/L; even more preferably, a concentration of the nitric acid solution is 1-8 mol/L.

Preferably, in the method for recovering active material from waste battery by desorption, step (5) can also comprise heating the soaked wound cores in step (4) under an atmosphere of inert gas nitrogen/argon and screening to obtain desorption powder of anode and copper foil; further preferably, a temperature of the heating is 50-550° C., and a duration of the heating is 30-90 min.

The beneficial effects of the present disclosure are:
1. In the method for recovering active material from waste battery by desorption of the present disclosure, the waste battery only needs to be discharged and disassembled, and no shredding process is required, which avoids the problem of the difficulty of sorting caused by the reduced particle size after 2-3 times of shredding. In addition, the cathode and anode materials can be effectively recovered, and the product has high economic value.
2. In the method for recovering active material from waste battery by desorption of the present disclosure, by mixing the disassembled wound cores with carbon tetrachloride and reacting with chlorine, the aluminum foil of the cathode current collector reacts with chlorine to generate aluminum chloride, while the anode copper foil does not react with chlorine. Aluminum chloride is easily soluble in carbon tetrachloride, avoiding the formation of a dense oxide film to cause the reaction to be interrupted. With the reaction of chlorine and aluminum foil, the active material of cathode gradually falls off, while the anode does not change, thus realizing the separation of cathode and anode, avoiding the steps of shredding and sorting, and reducing equipment investment.
3. In the method for recovering active material from waste battery by desorption of the present disclosure, through evaporative separation of carbon tetrachloride at low temperature, anhydrous aluminum chloride with high economic value is obtained, and carbon tetrachloride can be recycled after recycling.
4. In the method for recovering active material from waste battery by desorption of the present disclosure, during the reaction, chlorine can further oxidize the cathode material. In the subsequent water soaking, lithium salts, especially lithium iron phosphate cathode material can be directly extracted, and iron phosphate and lithium chloride can be recovered without destroying the olivine skeleton structure of the iron phosphate, which can be directly used as the precursor of the cathode material to be sintered with the lithium source to regenerate the lithium iron phosphate cathode material.
5. In the method for recovering active material from waste battery by desorption of the present disclosure, the temperature during the reaction is controlled at 120° C. or less, which avoids the melting of the binder, keeps the anode current collector unchanged, and facilitates the separation of anode materials.
6. In the method for recovering active material from waste battery by desorption of the present disclosure, nitric acid reacts with the copper foil of the anode current collector and thereby desorption is realized to obtain desorption powder of anode.

After reading and understanding the drawings and detailed description, other aspects can be understood.

### BRIEF DESCRIPTION OF DRA WINGS

The drawings are used to provide a further understanding of the technical solutions of the present application and form a part of the specification. They are used together with the Embodiments of the present application to explain the technical solutions of the present application and do not constitute a limitation on the technical solutions of the present application.

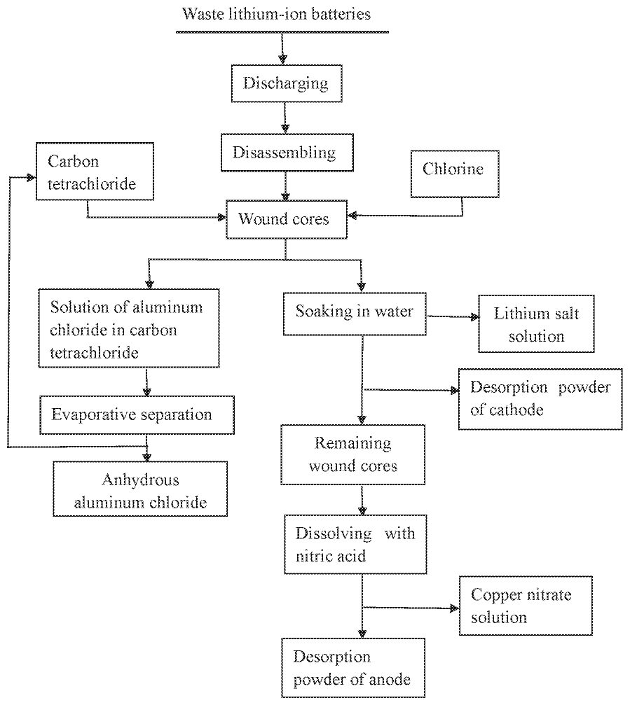

FIG. 1 is a schematic diagram of the method for recovering active material from waste battery by desorption in the examples of the present disclosure.

### DETAILED DESCRIPTION

The content of the present disclosure will be further illustrated in detail below through specific examples. Unless otherwise specified, the raw materials or devices used in the examples can be obtained from conventional commercial channels, or can be obtained by methods of the prior art. Unless otherwise specified, test or test methods are routine in the art.

### Example 1

Referring to the schematic diagram of FIG. 1, the method for recovering active material from waste battery by desorption in this example comprised steps of:
(1) After the waste lithium iron phosphate battery was discharged and disassembled, wound cores of cathode and anode current collectors were taken out and placed in a closed reaction kettle. Carbon tetrachloride was added to the reaction kettle until the wound cores of cathode and anode current collectors were immersed;
(2) Dry chlorine was introduced into the reaction kettle, and the reaction temperature in the kettle was controlled to be 120° C. A condenser was provided at the top of the reaction kettle with a condensation temperature of 50° C. or less, and the reaction ended when the solid was no longer reduced;
(3) After the reaction in step (2) was completed, the system was cooled to room temperature, and the unreacted wound cores were removed. Solid-liquid separation was performed to obtain a solution of aluminum chloride in carbon tetrachloride and first desorption powder of cathode. The solution of aluminum chloride in carbon tetrachloride was evaporated at low temperature for separation of aluminum chloride and carbon tetrachloride to obtain anhydrous aluminum chloride, and carbon tetrachloride was recovered;
(4) The unreacted wound cores and the first desorption powder of cathode in step (3) were added into deionized water to soak for 10 min, and the soaked wound cores were removed. Solid-liquid separation was performed to obtain a lithium salt solution and a delithiated second desorption powder of cathode; and
(5) The soaked wound cores in step (4) were added to a nitric acid solution with a concentration of 8 mol/L for reaction. After the reaction was completed, solid-liquid separation was performed to obtain a copper nitrate solution and desorption powder of anode.

### Example 2

Referring to the schematic diagram of FIG. 1, the method for recovering active material from waste battery by desorption in this example comprised steps of:
(1) After the waste ternary lithium-ion battery was discharged and disassembled, wound cores of cathode and anode current collectors were taken out and placed in a closed reaction kettle. Carbon tetrachloride was added to the reaction kettle until the wound cores of cathode and anode current collectors were immersed;
(2) Dry chlorine was introduced into the reaction kettle, and the reaction temperature in the kettle was controlled to be 100° C. A condenser was provided at the top of the reaction kettle with a condensation temperature of 50° C. or less, and the reaction ended when the solid was no longer reduced;
(3) After the reaction in step (2) was completed, the system was cooled to room temperature, and the unreacted wound cores were removed. Solid-liquid separation was performed to obtain a solution of aluminum chloride in carbon tetrachloride and first desorption powder of cathode. The solution of aluminum chloride in carbon tetrachloride was evaporated at low temperature for separation of aluminum chloride and carbon tetrachloride to obtain anhydrous aluminum chloride, and carbon tetrachloride was recovered;
(4) The unreacted wound cores and the first desorption powder of cathode in step (3) were added into deionized water to soak for 20 min, and the soaked wound cores were removed. Solid-liquid separation was performed to obtain a lithium salt solution and a second desorption powder of cathode;
(5) The soaked wound cores in step (4) were added to a nitric acid solution with a concentration of 4 mol/L for reaction. After the reaction was completed, solid-liquid separation was performed to obtain a copper nitrate solution and desorption powder of anode.

### Example 3

Referring to the schematic diagram of FIG. 1, the method for recovering active material from waste battery by desorption in this example comprised steps of:
(1) After the waste lithium cobalt oxide battery was discharged and disassembled, wound cores of cathode and anode current collectors were taken out and placed in a closed reaction kettle. Carbon tetrachloride was added to the reaction kettle until the wound cores of cathode and anode current collectors were immersed;
(2) Dry chlorine was introduced into the reaction kettle, and the reaction temperature in the kettle was controlled to be 80° C. A condenser was provided at the top of the reaction kettle with a condensation temperature of 50° C. or less, and the reaction ended when the solid was no longer reduced;
(3) After the reaction in step (2) was completed, the system was cooled to room temperature, and the unreacted wound cores were removed. Solid-liquid separation was performed to obtain a solution of aluminum chloride in carbon tetrachloride and first desorption powder of cathode. The solution of aluminum chloride in carbon tetrachloride was evaporated at low temperature for separation of aluminum chloride and carbon tetrachloride to obtain anhydrous aluminum chloride, and carbon tetrachloride was recovered;
(4) The unreacted wound cores and the first desorption powder of cathode in step (3) were added into deionized water to soak for 30 min, and the soaked wound cores were removed. Solid-liquid separation was performed to obtain a lithium salt solution and a second desorption powder of cathode;
(5) The soaked wound cores in step (4) were added to a nitric acid solution with a concentration of 1 mol/L for reaction. After the reaction was completed, solid-liquid separation was performed to obtain a copper nitrate solution and desorption powder of anode.

1. A method for recovering active material from waste battery by desorption, comprising steps of
(1) mixing a wound core of cathode current collector and a wound core of anode current collector of waste lithium-ion battery with carbon tetrachloride in a reaction device;
(2) introducing chlorine into the reaction device in step (1) for reaction;
(3) removing the remaining wound cores after the reaction in step (2), and performing solid-liquid separation on the remaining material in the reaction device to obtain a solution of aluminum chloride in carbon tetrachloride and a first desorption powder of cathode;
(4) soaking the wound cores and the first desorption powder of cathode in step (3) in water, removing the soaked wound cores, and performing solid-liquid separation on the remaining material to obtain a lithium salt solution and a second desorption powder of cathode; and
(5) reacting the soaked wound cores in step (4) with a nitric acid solution and performing solid-liquid separation to obtain a copper nitrate solution and a desorption powder of anode,
wherein in step (1), the wound core of cathode current collector and the wound core of anode current collector of waste lithium-ion battery are obtained by discharging and disassembling the waste lithium-ion battery; and
in step (1), the wound core of cathode current collector includes aluminum foil and the wound core of anode current collector includes copper foil.

2. The method according to claim 1, wherein in step (1), the waste lithium-ion battery includes at least one selected from the group consisting of ternary lithium-ion battery, lithium iron phosphate battery, lithium cobalt oxide battery, lithium manganate battery and lithium nickelate battery.

3. The method according to claim 1, wherein in step (2), a temperature of the reaction is 70-120° C.

4. The method according to claim 1, wherein the top of the reaction device is provided with a condenser.

5. The method according to claim 4, wherein a condensation temperature of the condenser is ≤60° C.

6. The method according to claim 1, wherein step (3) further comprises a separation step of aluminum chloride and carbon tetrachloride: evaporating the solution of aluminum chloride in carbon tetrachloride to obtain anhydrous aluminum chloride and carbon tetrachloride.

7. The method according to claim 1, wherein in step (4), a duration of soaking in water is 6-40 min.

8. The method according to claim 1, wherein in step (5), a concentration of the nitric acid solution is 0.5-9 mol/L.

9. The method according to claim 6, wherein the process of evaporating the solution of aluminum chloride in carbon tetrachloride to obtain anhydrous aluminum chloride and carbon tetrachloride is conducted at the temperature of 70-75° C.
